(19) United States
(12) Patent Application Publication
(10) Pub. No.: US 2007/0138830 A1
(43) Pub. Date: Jun. 21, 2007

(54) Method and system for controlling pressure in a vehicle

(76) Inventor: Emad S. Isaac, Woodridge, IL (US)

Correspondence Address: MOTOROLA, INC., 1303 EAST ALGONQUIN ROAD, IL01/3RD, SCHAUMBURG, IL, 60196, US

(21) Appl. No.: 11/312,104

(22) Filed: Dec. 20, 2005

(51) Int. Cl. B60J 1/12

(52) U.S. Cl. 296/146.16

(57) ABSTRACT

A method and system for controlling pressure in a vehicle (100) is disclosed. The method includes operating at least one of one or more secondary windows and one or more air vents in the vehicle (100) while a primary window (202) is being operated. The system includes a controller (206) and a device (204). The controller (206) is configured to detect the operation of the primary window in the vehicle. The device is configured to provide a second path to an external environment that is managed by the controller (206).

### FIELD OF THE INVENTION

This invention relates in general to vehicles, and more specifically to controlling ambient pressure in a vehicle.

### BACKGROUND OF THE INVENTION

The air inside the cabin of a vehicle is maintained at an ambient temperature and pressure for the comfort of passengers traveling in it. The difference in the ambient pressure inside the vehicle, called cabin pressure, and the pressure outside it, as experienced by a person inside the vehicle, increases with increasing speed of the vehicle. When one or more windows in a moving vehicle are opened, there is a sudden change in its cabin pressure. This causes discomfort to the driver and passengers in the vehicle.

A need exists to provide a system and method to overcome or minimize most, if not all, of the preceding problems especially in the area of controlling ambient pressure in a moving vehicle.

### BRIEF DESCRIPTION OF THE DRAWINGS

The present invention is illustrated by way of example and not limitation in the accompanying figures, in which like references indicate similar elements, and in which:

FIG. 1 shows an exemplary environment, in accordance with an embodiment of the invention.

FIG. 2 shows a block diagram of a vehicle, in accordance with an exemplary embodiment of the invention.

FIG. 3 is a flowchart illustrating one embodiment of a method for controlling pressure in the vehicle.

FIG. 4 is a flowchart illustrating another embodiment for controlling pressure in the vehicle.

FIG. 5 is a flowchart illustrating a further embodiment for controlling pressure in the vehicle.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

A method and system for controlling pressure in a vehicle is disclosed. The vehicle includes a primary window, one or more secondary windows, and one or more air vents. The primary window opens a first path to an external environment. The one or more secondary windows and/or the air vents open a second path to the external environment. The method includes operating the one or more windows and/or one or more air vents when the primary window is being operated.

Before describing in detail the particular method and system for controlling pressure in a vehicle in accordance with the present invention, it should be observed that the present invention resides primarily in combinations of method steps and apparatus components related to controlling pressure in a vehicle. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

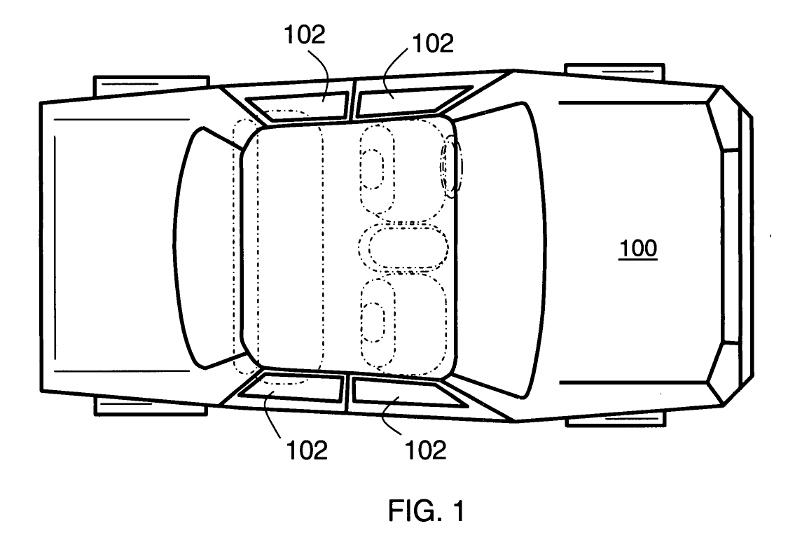

FIG. 1 shows an exemplary environment, in accordance with an embodiment of the invention. The environment is a vehicle 100 that includes a plurality of windows 102. The vehicle may further include one or more air vents (not shown in FIG. 1).

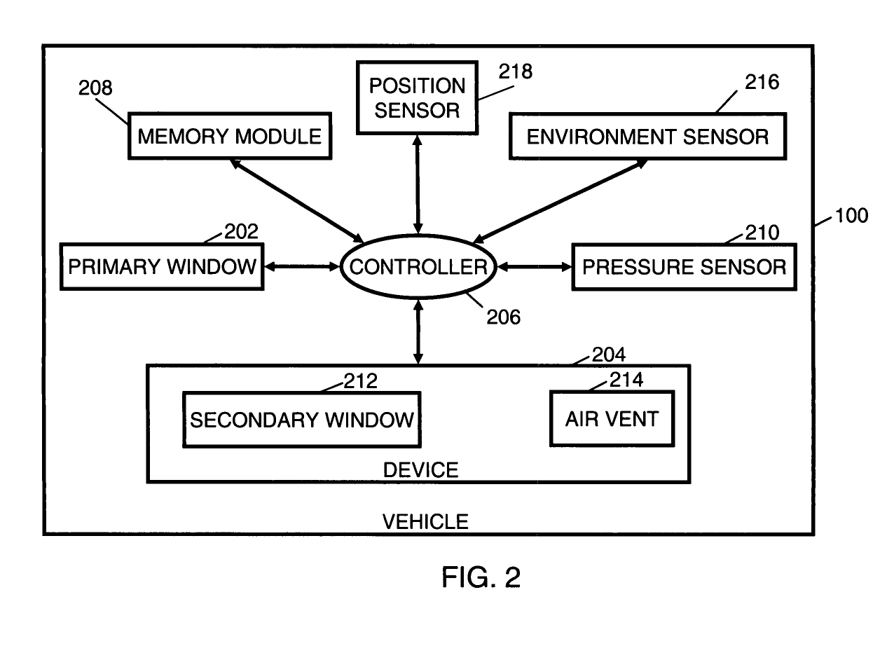

FIG. 2 shows a block diagram of a vehicle, in accordance with an exemplary embodiment of the invention. The vehicle 100 includes a primary window 202, a device 204, a controller 206, a memory module 208, a pressure sensor 210, an environment sensor 216 and a position sensor 218. The device 204 includes one or more secondary windows, such as secondary window 212; and one or more air vents, such as air vent 214.

In accordance with an embodiment of the invention, the primary window 202 is one of the plurality of door windows 102, operated by a passenger or the driver in the vehicle 100. The primary window 202 provides a first air path to an external environment. The external environment is the environment outside the cabin of the vehicle 100.

The device 204 provides a second air path to the external environment and managed by the controller 206. The device is operated after the operation of the primary window 202. In accordance with one embodiment of the invention, the device 204 may be a secondary window 212. The secondary window 212 is one or more of the plurality of door windows 102 other than the primary window 202. In accordance with another embodiment of the invention, the device 204 may be the air vent 214 in the vehicle 100. The air vent may be configured to operate in combination with the secondary window 212 or as an alternative. When acting as an alternative to the secondary window 212, the controller 206 may be configured to monitor the environment sensor 216. The environment sensor 216 may indicate to the controller 206 that the opening of the secondary window 212 is not desirable (such as if it is raining outside or extreme temperature conditions exist). The environment sensor 216 may be a sensor that monitors a weather condition such as moisture, temperature or pressure. Additionally, the environment sensor 216 may be a sensor that monitors a set of vehicle window wipers that can provide certain information based on whether the wipers are active or not active. In any case, the controller 206 may make a determination of whether to open the air vent 214 instead of the secondary window 212 based on information from the environment sensor 216. In accordance with yet another embodiment of the invention, the device 204 may be a combination of the secondary window 212 and the air vent 214.

The controller 206 detects the operation of the primary window 202 and controls the operation of the device 204. In one embodiment of the invention, the controller 206 may contain programmable logic embedded in a chip that performs functions related to the operation of the primary window 202 and the device 204. The controller 206 detects the opening and closing of the primary window 202 and controls the opening or closing of the device 204, based on the operation of the primary window 202. In a further embodiment, the controller 206 may be configured to determine whether the vehicle is moving, and controls the operation of the device 204, based on the speed of the vehicle. In an embodiment of the invention, the controller 206 receives data related to the speed of the vehicle 100 from an Engine Control Unit (ECU). Additionally, the controller 206 may be configured to operate the secondary window 212 or air vent 214 based on information from the pressure sensor 210, the memory module 208 containing user preferences, or the external environment sensor 216. For instance, the controller 206 can be configured to detect weather conditions (for example, rain or extreme temperatures) in the external environment and send commands to the device 204 based on the weather conditions of the external environment.

The controller 206 can also determine a user preference pertaining to the selection of the primary window 202 and the device 204 and sends commands to the device 204 in response to determining the user preference. The user preference may be based on the history of the operation of the primary window 202 and the selection of the device 204 by the passenger and/or driver of the vehicle 100. The user preference may also be pre-programmed by the user based on factors such as desired second air paths, external environment conditions, and desired pressure in the cabin. The user preference may also include the rate at which the device 204 is opened or closed. In accordance with an embodiment of the invention, the device 204 may not be opened completely, but a fraction, as set by a user. The user preference may further include an optimal selection of the number of secondary windows and air vents that are to be operated. For example, if the external environment is such that opening one or more secondary windows is not desirable, e.g., if there is rain, then one or more air vents are opened.

Table 1 is a look-up table, in accordance with an exemplary embodiment of the invention. The look-up table may be used to determine a combination of secondary windows and air vents that need to be operated when a primary window is operated, depending on the number of windows in the vehicle 100.

TABLE 1
A Look-up table

If num_windows = = 2 then
If primary = driver then secondary = passenger
If num_windows = = 4 then
If primary = driver then secondary = passenger
If primary = passenger then secondary = rear_right_passenger
If primary = rear_right_passenger then secondary = passenger

In one embodiment of the invention, the look-up table is stored in the memory module 208. The memory module 208 may be configured to store the user preferences as set by the passengers and/or driver of the vehicle 100. Further, the user preferences in the memory module 208 can be changed, depending on the passengers and/or driver of the vehicle 100.

The pressure sensor 210 may be an internal pressure sensor that is installed inside the vehicle 100 and provides the controller 206 with data related to air pressure in the cabin of the vehicle 100. The controller 206 may be configured to control the second air path based on monitoring the pressure sensor 210 and maintaining it at or below a certain desired cabin pressure.

The position sensor 218 may be a Global Positioning System (GPS) device, dead reckoning unit, or other device or system that determines the location of the vehicle. The position sensor 218 provides the controller 206 with the position of the vehicle. In a further embodiment, the controller 206 is configured to control the second air path based on the location of the vehicle.

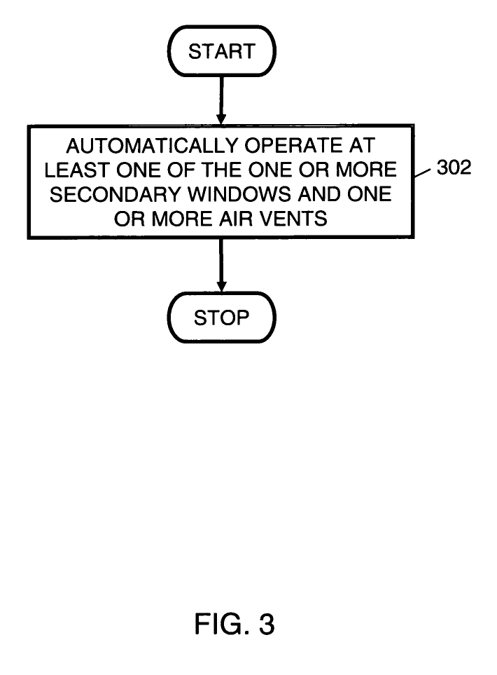

FIG. 3 is a flowchart illustrating a method for controlling pressure in the vehicle 100, in accordance with an exemplary embodiment of the invention. At step 302, the controller 206 automatically operates the one or more secondary windows and/or the one or more air vents while the primary window 202 is being operated. The operation of the one or more secondary windows and/or one or more air vents while the primary window 202 is operated prevents a sudden change in the cabin pressure of the vehicle 100. For example, if all the windows in the vehicle 100 are closed and the primary window 202 is opened to the external environment, the controller 206 automatically opens the one or more secondary windows and/or the one or more air vents in the vehicle 100 to the external environment. The rate at which the one or more secondary windows and/or the one or more air vents are opened is controlled by the controller 206 and may depend on manufacturer design or a function of the user preferences. In accordance with an embodiment of the invention, the rate at which at least one of the one or more secondary windows and one or more air vents are opened may be different from the rate at which the primary window 202 is opened. If the primary window 202 is closed to the external environment, the controller 206 automatically closes at least one of the one or more secondary windows and one or more air vents in the vehicle 100. The rate at which the one or more secondary windows and/or the one or more air vents are closed is controlled by the controller 206 and depends on the user preference. In accordance with an embodiment of the invention, the rate at which the one or more secondary windows and/or the one or more air vents are closed may be different from the rate at which the primary window 202 is closed. Furthermore, in one embodiment of the invention, the selection of the number of secondary windows and air vents and opening rate depends on the speed of the vehicle 100.

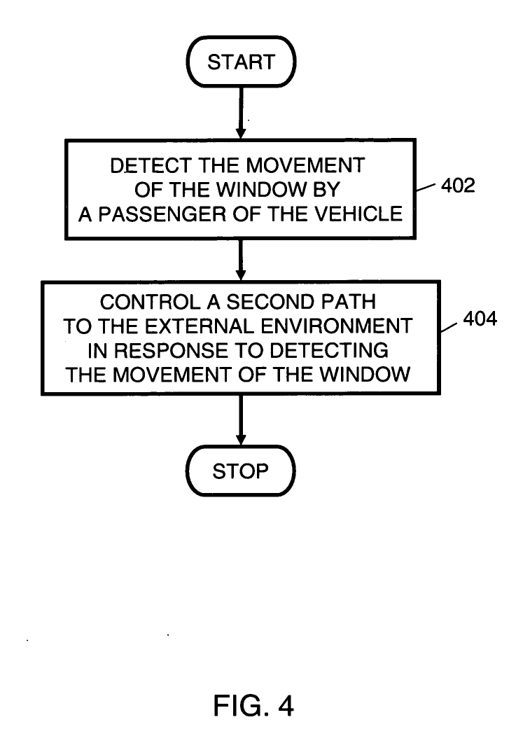

FIG. 4 is a flowchart of another embodiment for controlling pressure in the vehicle. At step 402, the controller 206 detects the movement of the primary window 202 by a driver or a passenger of the vehicle 100. This includes detecting either a command to open the primary window 202 or detecting a command to close the primary window 202. The opening of the primary window 202 results in a first air path to the external environment. At step 404, the controller 206 controls a second air path to the external environment when it detects the movement of the primary window 202. If the primary window 202 is opened to the external environment, the controller 206 automatically opens the one or more secondary windows and/or one or more air vents in the vehicle 100 to the external environment. The rate at which the one or more secondary windows and/or the one or more air vents are opened is controlled by the controller 206 and may depend on manufacturer design or a function of the user preferences. In an embodiment of the present invention, the rate at which the one or more secondary windows and/or the one or more air vents are opened may be different from the rate at which the primary window 202 is opened. On the other hand, if the primary window 202 is closed to the external environment, the controller 206 automatically closes the one or more secondary windows and/or the one or more air vents in the vehicle 100 to the external environment. The rate at which one or more secondary windows and/or one or more air vents are closed is controlled by the controller 206 and may depend on manufacturer design or a function of the user preferences. In an embodiment of the present invention, the rate at which the one or more secondary windows and/or the one or more air vents is closed may be different from the rate at which the primary window 202 is closed.

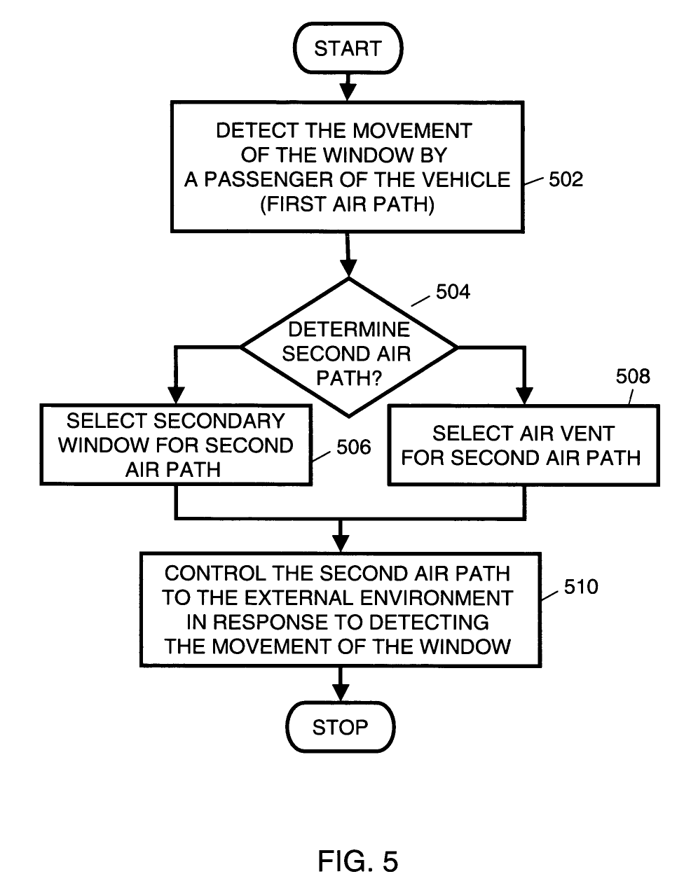

FIG. 5 is a flowchart of a further embodiment for controlling pressure in the vehicle. At step 502, the controller 206 detects the movement of the primary window 202 by a driver or a passenger of the vehicle 100. This includes detecting either a command to open the primary window 202 or detecting a command to close the primary window 202. The opening of the primary window 202 creates a first air path to the external environment. At step 504, the controller 206 will then make a determination of creating a second air path to the external environment. This determination may be made based on a variety of considerations. In one embodiment, the selection of a second air path may be made based on monitoring the external environment sensor 216 as described above. In further embodiments, the selection of a second air path may be made on user preferences or by other vehicle sensors that provide vehicle speed or air pressures. Depending on the configuration, the controller 206 may select different air paths such as a secondary window 212 (as shown in step 506) or an air vent 214 (as shown in step 508).

In step 510, the controller 206 controls the second air path to the external environment. The rate at which the one or more secondary windows and/or the one or more air vents are opened is controlled by the controller 206 and may depend on manufacturer design or a function of the user preferences. In an embodiment of the present invention, the rate at which the one or more secondary windows and/or the one or more air vents are opened may be different from the rate at which the primary window 202 is opened. On the other hand, if the primary window 202 is closed to the external environment, the controller 206 automatically closes the one or more secondary windows and/or the one or more air vents in the vehicle 100 to the external environment. The rate at which one or more secondary windows and/or one or more air vents are closed is controlled by the controller 206 and may depend on manufacturer design or a function of the user preferences. In an embodiment of the present invention, the rate at which the one or more secondary windows and/or the one or more air vents is closed may be different from the rate at which the primary window 202 is closed.

It will be appreciated that the controller described herein may be comprised of one or more conventional processors and unique stored program instructions that control the one or more processors to implement, in conjunction with certain non-processor circuits, some, most, or all of the functions of the controller described herein. The non-processor circuits may include, but are not limited to, a radio receiver, a radio transmitter, signal drivers, clock circuits, power source circuits, and user input devices. As such, these functions may be interpreted as steps of a method to perform {accessing of a communication system}. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for controlling a pressure in a vehicle, the vehicle having a primary window, one or more secondary windows, and one or more air vents, the method comprising:
automatically operating at least one of the one or more secondary windows and one or more air vents in the vehicle while the primary window is being operated.

2. The method according to claim 1 wherein the primary window may be operated by either opening the primary window or closing the primary window to an external environment, the method further comprising the steps of:
if the primary window is being operated by opening the primary window to the external environment, then automatically opening at least one of the one or more secondary windows and one or more air vents in the vehicle to the external environment; and
if the primary window is being operated by closing the primary window to the external environment, then automatically closing at least one of the one or more secondary windows and one or more air vents in the vehicle to the external environment.

3. The method according to claim 1 wherein automatically operating the one or more secondary windows comprises storing at least one user preference, the at least one user preference depicting a combination of the primary window, the one or more secondary windows, and the one or more air vents to be operated.

4. The method according to claim 3 further comprising the step of selecting at least one of the one or more secondary windows and the one or more air vents to be operated, the selection being based on one or more of a group consisting of the at least one user preference, a speed of the vehicle, an environmental condition, and a vehicle location.

5. A method for controlling a pressure in a vehicle, the vehicle having a primary window that opens a first path to an external environment, the method comprising:
detecting the movement of the primary window by a passenger of the vehicle; and
controlling a second path to the external environment in response to detecting the movement of the primary window.

6. The method according to claim 5 wherein the step of detecting the movement of the primary window includes detecting a command to open the primary window and the step of controlling the second path to the external environment includes opening one or more secondary windows in the vehicle.

7. The method according to claim 5 wherein the step of detecting the movement of the primary window includes detecting a command to open the primary window and the step of controlling the second path to the external environment includes opening one or more air vents in the vehicle.

8. The method according to claim 5 wherein the step of detecting the movement of the primary window includes detecting a command to close the primary window and the step of controlling the second path to the external environment includes closing one or more secondary windows in the vehicle.

9. The method according to claim 5 wherein the step of detecting the movement of the primary window includes detecting a command to close the primary window and the step of controlling the second path to the external environment includes closing one or more air vents in the vehicle.

10. The method according to claim 5 further comprising the step of determining whether the vehicle is moving, wherein the step of controlling the second path to the external environment is in further response to determining whether the vehicle is moving.

11. The method according to claim 5 further comprising the step of determining a user preference, wherein the step of controlling the second path to the external environment is in further response to determining the user preference.

12. The method according to claim 11 further comprising the step of determining a vehicle location, wherein the step of controlling the second path to the external environment is in further response to the vehicle location.

13. The method according to claim 5 further comprising the step of determining a weather condition of the external environment, wherein the step of controlling the second path to the external environment is in further response to determining the weather condition of the external environment.

14. The method according to claim 5 wherein the step of detecting the movement of the primary window by a passenger of the vehicle includes the step of monitoring the pressure in the vehicle.

15. A system for controlling a pressure in a vehicle, the vehicle having a primary window that opens a first path to an external environment, the system comprising:
a controller that is capable of detecting the operation of the primary window in the vehicle; and
a device that provides a second path to the external environment, the device capable of receiving commands from the controller to open or close the second path to the external environment in response to detecting the operation of the primary window in the vehicle.

16. The system according to claim 15 wherein the device is at least one of one or more secondary windows and one or more air vents.

17. The system according to claim 15 wherein the controller is further capable of determining whether the vehicle is moving, wherein the device that provides the second path further receives commands from the controller in response to determining whether the vehicle is moving.

18. The system according to claim 15 wherein the controller is further capable of determining a user preference, wherein the device that provides the second path further receives commands from the controller in response to determining the user preference.

19. The system according to claim 15 wherein the controller is further capable of detecting a weather condition of the external environment, wherein the device that provides the second path further receives commands from the controller in response to detecting the weather condition of the external environment.

20. The system according to claim 15 wherein the system further includes a pressure sensor that provides the controller with an air pressure in the vehicle.
